(19) United States
(12) Patent Application Publication
(10) Pub. No.: US 2008/0169155 A1
(43) Pub. Date: Jul. 17, 2008

(54) PULLEY SYSTEM FOR A TREE STAND

(76) Inventor: JAMES E. BROBERG, Crystal Lake, IL (US)

Correspondence Address: Mathew R. P. Perrone, Jr.;Brie A. Crawford, 210 South Main Street, Algonquin, IL, 60102, US

(21) Appl. No.: 11/623,202

(22) Filed: Jan. 15, 2007

(51) Int. Cl. A01M 31/02; E04G 3/32

(52) U.S. Cl. 182/187; 254/409

(57) ABSTRACT

A pulley system for a tree stand is positioned in tree at a desired point. A bracket for the pulley system supports securing device and a pulley assembly as part of the pulley system. The tree stand is attached to a rope in the pulley system. Then the rope and pulley cooperate to lift the stand to a desired position for mounting.

This invention relates to a pulley system and more particularly to a pulley system for a tree stand for use in hoisting the tree stand up the tree and positioning it at the desired height in the tree so that the tree stand may be properly positioned without the need for a hunter to physically carry the tree stand up the tree.

### BACKGROUND OF THE INVENTION

In hunting, a tree stand can give a hunter a great vantage point for spotting target animals at greater distances. A tree stand can also help to conceal the hunter and the hunter's scent from target animals on the ground.

In order to provide a proper platform on which to stand, the platform must provide a suitable surface area where a hunter may rest his or her feet. The surface area requirement lease to at least a bulky system and to the above and possibly a heavy system. Either the size or the weight can cause a problem with the tree stand. Yet, size or weight are the obvious results of the device being sturdy and suitable for use in hunting.

Furthermore, safety issues with the installation of removable tree stands do exist. The hunter must use a climbing stick or screw in pegs to reach the top of the tree. In the prior art, the hunter had to carry the tree stand, usually on his shoulder or one hand, up the tree, thus leaving only one hand to maneuver while using the climbing stick or screw in pegs. This multitasking creates at least one dangerous situation, because the hunter can risk a fall of ten feet or greater. Also, the cumbersome tree stand creates a difficulty in balancing while the hunter is climbing.

### SUMMARY OF THE INVENTION

Among the many objective of the present invention is the provision of a pulley system for a tree stand that allows the tree stand to be hoisted into the tree by either one or more hunters.

Another objective of the present invention is the provision of a pulley system for a tree stand that eliminates the safety concerns associated with carrying a tree stand up a climbing ladder, screw in pegs, or other climbing apparatus.

Moreover an objective of the present invention is a system that is not cumbersome to carry up a ladder.

A still further objective of the present invention is the provision of a pulley system for a tree stand that is suitable for use with a wide variety of tree stands.

Moreover, an objective of the present invention is the provision of a pulley system for a tree stand which is easy to use.

Also, an objective of the present invention is the provision of a pulley system for a tree stand which is easy to transport.

A further objective of the present invention is the provision of a pulley system for a tree stand which allows the tree stand to be positioned in the tree by a single hunter or a plurality of hunters.

A still further objective of the present invention is the provision of a pulley for a tree stand which can be strapped around the trunk of the tree or screwed into the trunk of the tree.

These system and other objectives of the invention (which other objectives become clear by consideration of the specification, claims and drawings as awhole) are met by providing a pulley system for a tree stand which allows the hunter to hoist the tree stand up into the tree without the need to physically carry it up the tree.

### BRIEF DESCRIPTION OF THE DRAWINGS

FIG. 1 depicts a perspective view of pulley system 100.

FIG. 2 depicts a perspective view of pulley system 100 attached to tree 102 and tree stand 104.

FIG. 3 depicts a perspective view of pulley system 100 attached to tree stand 104.

FIG. 4 depicts a front view of pulley assembly 116 of pulley system 100.

FIG. 5 depicts a back view of pulley assembly 116 of pulley system 100.

FIG. 6 depicts a top view of pulley assembly 116 of pulley system 100.

FIG. 7 depicts a side view of pulley assembly 116 of pulley system 100.

FIG. 8 depicts an exploded perspective view of pulley assembly 116 of pulley system 100.

FIG. 9 depicts a perspective view of pulley system 100 using a fixed screw to support the housing 106.

FIG. 10 depicts a box diagram of pulley system 100.

Throughout the figures of the drawings, where the same part appears in more than one figure of the drawings, the same number is applied thereto.

### DESCRIPTION OF THE PREFERRED EMBODIMENTS

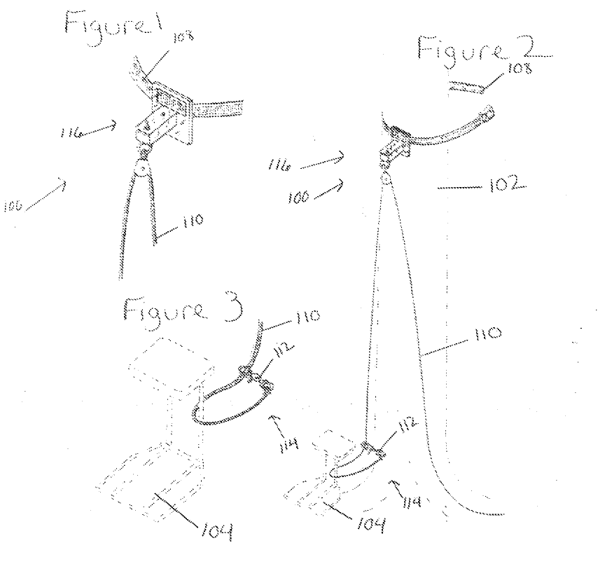

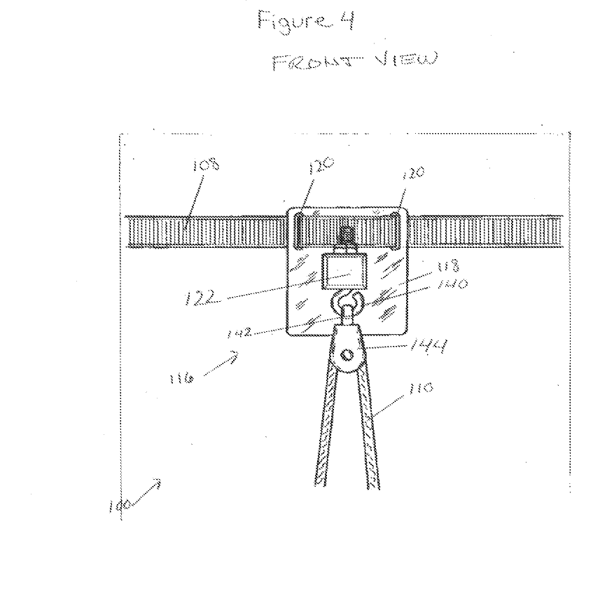

The subject of the present invention solves these safety concerns by providing a pulley system for hoisting a tree stand up into a tree. This pulley Referring to FIG. 1, FIG. 2, and FIG. 3, the structure of pulley system 100 can be clearly seen. Pulley system 100 has strap 108 which securely holds pulley system 100 in the desired position on tree 102. The desired position is the height at which the hunter wants to be above the ground. The hunter places strap 108 around tree 102 at the desirable height where tree stand 104 is to be placed.

Pulley system 100 also has a pulley assembly 116 which moves tree stand 104 up tree 102. Rope 110 weaves through pulley assembly 116. Rope 110 also attaches to tree stand 104 at attachment end 114. Thus, pulley system 100 is able to hoist tree stand 104 into tree 102.

Pulley system 100 also has rope 110 which attaches to tree stand 104 so that it may be hoisted up tree 102. Rope 110 has an attachment end for securely connecting it to tree stand 104. The hunter secures attachment end 114 of rope 110 and wraps it around tree stand 104 and secures the connection with attachment mechanism 112. Attachment mechanism can be any suitable mechanism such as a clasp or a knot.

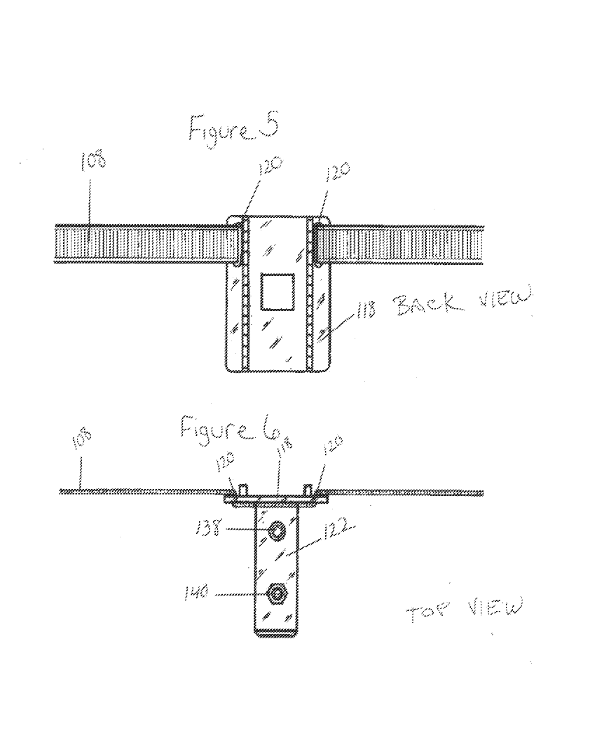

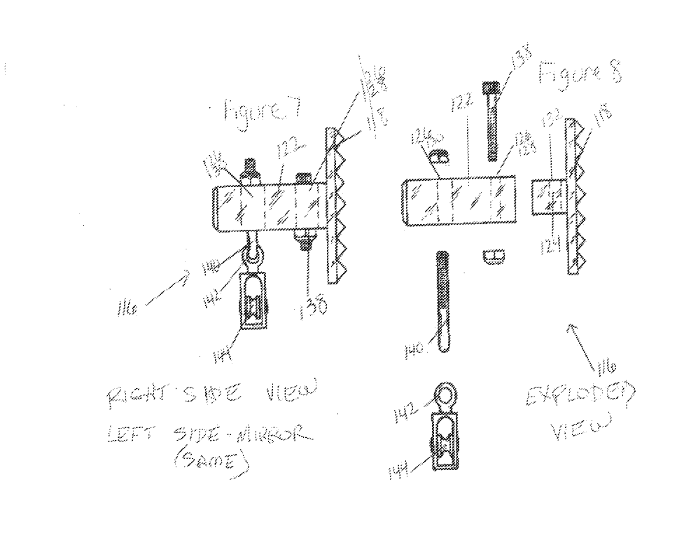

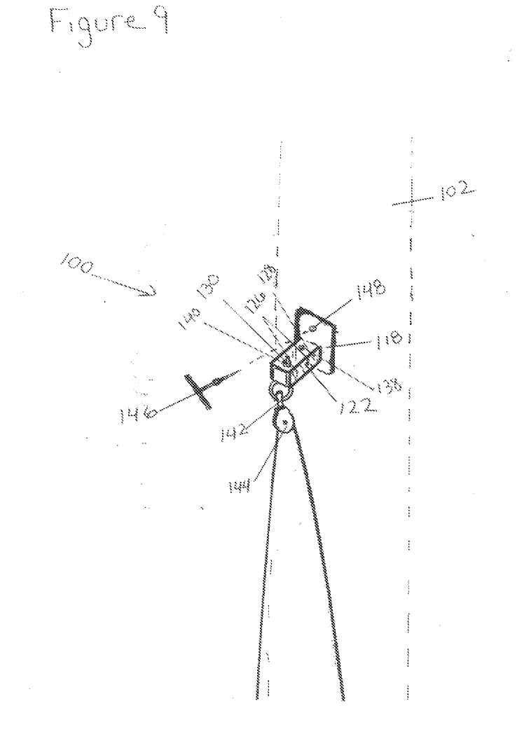

Adding FIG. 4, FIG. 5, FIG. 6, FIG. 7, and FIG. 8 to the consideration the structure of pulley assembly 116 can be clearly seen. Mounting bracket 118 has two bracket apertures 120. Strap 108 weaves through each bracket aperture 120 to form a secure attachment to mounting bracket 118.

Mounting bracket 118 has mounting stub 124 attached to it. Mounting stub 124 cooperates with mounting rod 122 in a male to female relationship which causes mounting stub apertures 132 and mounting rod apertures 126 to evenly align. Mounting stub aperture 134 and first mounting rod aperture 128 receive standard bolt 138 to form a secure and stable connection between the pair.

Second mounting rod aperture 130 receive eye bolt 140. Eye bolt 140 hooks on pulley loop 142 so that pulley 144 is able to hang from the mounting rod 122 and mounting stub 124 combination. Rope 110 wraps around pulley 144.

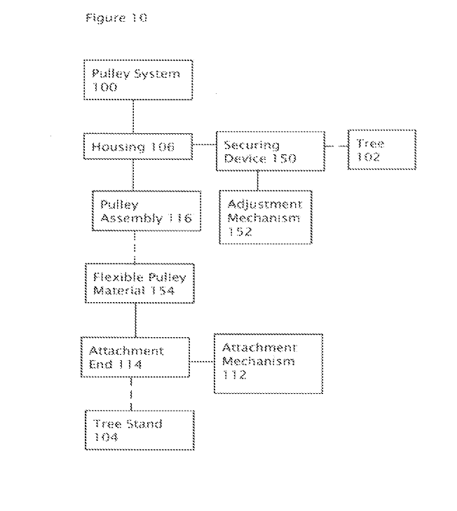

Adding FIG. 9 to the consideration, an alternate embodiment of pulley system 100 can be clearly seen. In this embodiment, strap 108 (as shown in FIG. 1) is replaced by mounting screw 146. Mounting screw 146 attaches to the back of mounting bracket 118 through mounting aperture 148. Mounting screw 146 can be screwed into tree 102 to securely attach pulley system 100 in the desired position. Mounting screw 146 can be any suitable screw including a T-screw.

Mounting bracket 118 has mounting stub 124 (as shown in FIG. 8) attached to it. Mounting stub 124 cooperates with mounting rod 122 in a male to female relationship which causes mounting stub apertures 132 (as shown in FIG. 8) and mounting rod apertures 126 to evenly align. Mounting stub aperture 134 and first mounting rod aperture 128 receive standard bolt 138 to form a secure and stable connection between the pair.

Second mounting rod aperture 130 receive eye bolt 140. Eye bolt 140 hooks on pulley loop 142 so that pulley 144 is able to hang from the mounting rod 122 and mounting stub 124 combination. Rope 110 wraps around pulley 144.

With the consideration of FIG. 10, pulley system 100 has a housing 106 with a securing device 150 for securing the housing 106 to the tree 102, so that pulley assembly 116 may be used. Securing device 150 may use any suitable devices, which fasten together, and may be separated as desired. Typically buckles, snaps and a hook and loop assembly work as securing device 150. Further appropriate securing devices are disclosed in U.S. Pat. No. 5,421,498, to Menoni incorporated herein by reference. Securing device 150 also includes and adjustment mechanism 152 for tightening or loosening securing device 150 as desired.

Pulley assembly 116 attaches to tree stand 104 through attachment end 114 of flexible pulley material 154. In the previous embodiments, flexible pulley material 154 is rope 110. However, flexible pulley material 154 may also be a cable, strap, or any other flexible material suitable for use with pulley system 100. Attachment end 114 has attachment mechanisms 112 which can be a buckle, clasp, hook and loop assembly, or any other suitable devices which may be tightened and loosened.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this method and apparatus can become clear to a person having ordinary skill in this particular art. Such modifications are clearly covered by this disclosure.

What is claimed and sought to be protected by Letters Patent of the United States is:

1. A pulley system for mounting a hunting stand in a tree comprising:
a) the pulley system having a mounting bracket, a securing means, and the pulley assembly;
b) the mounting bracket, the securing means, and the pulley assembly cooperating to permit the pulley system to work on a tree stand;
c) the securing means being adapted to releasably secure the mounting bracket at a desired position;
d) the securing means being secured to the mounting bracket;
e) the pulley assembly being secured to the mounting bracket;
f) the pulley assembly being at least partially movable relative to the mounting bracket; and
g) the pulley assembly being attachable to a device to be lifted.

2. The pulley assembly of claim 1 further comprising:
a) the securing means being a flexible strap;
b) the flexible strap being fastenable in order to secure the mounting bracket at a desired position and use the pulley assembly;
c) a rope cooperating with the pulley assembly in order to lift a device; and
d) a fastening means for releasably securing the device to the rope.

3. The pulley assembly of claim 2 further comprising:
a) the mounting bracket having at least one bracket aperture;
b) the at least one bracket aperture receiving the flexible strap in order to hold the mounting bracket at the desired position when the flexible strap is joined;
c) the mounting bracket having a mounting stub attached thereto; and
d) the mounting stub cooperating with a mounting rod.

4. The pulley assembly of claim 3 further comprising:
a) the mounting stub including a mounting stub aperture;
b) the mounting rod including a first mounting rod aperture;
c) a bolt fitting through the mounting stub aperture and the first mounting rod aperture;
d) the mounting rod including a second mounting rod aperture;
e) an eye bolt being mounted in the second mounting rod aperture; and
f) a pulley being mounted on the eye bolt.

5. The pulley assembly of claim 4 further comprising:
a) the rope feeding through the pulley system;
b) the rope having a device attachment in order to secure a device for lifting the device into the tree; and
c) the mounting bracket cooperating with the rope.

6. The pulley assembly of claim 1 further comprising:
a) the securing means being a mounting screw;
b) the mounting screw being secured to a back of the mounting bracket; and
c) the mounting screw being securable to a tree on order to securely attach the pulley system in a desired position.

7. The pulley assembly of claim 6 further comprising:
a) the mounting bracket having at least one bracket aperture;
b) the at least one bracket aperture receiving the flexible strap in order to hold the mounting bracket at the desired position when the flexible strap is joined;
c) the mounting bracket having a mounting stub attached thereto;
d) the mounting stub cooperating with a mounting rod
e) a rope cooperating with the pulley assembly in order to lift a device; and
f) a fastening means for releasably securing the device to the rope.

8. The pulley assembly of claim 7 further comprising:
a) the mounting stub including a mounting stub aperture;
b) the mounting rod including a first mounting rod aperture;
c) a bolt fitting through the mounting stub aperture and the first mounting rod aperture;
d) the mounting rod including a second mounting rod aperture;
e) an eye bolt being mounted in the second mounting rod aperture; and
f) a pulley being mounted on the eye bolt.

9. The pulley assembly of claim 8 further comprising:
a) the rope feeding through the pulley system;
b) the rope having a device attachment in order to secure a device for lifting the device into the tree; and
c) the mounting bracket cooperating with the rope.

10. A pulley system for mounting a hunting stand in a tree comprising:
a) the pulley system having a mounting bracket with a securing device for securing the mounting bracket to a tree on the mounting bracket and a pulley system on the mounting bracket; and
b) the securing device being removably joinable to the tree and permanently secured to the mounting bracket.

11. The pulley assembly of claim 10 further comprising:
a) the securing means being a flexible strap;
b) the flexible strap being fastenable in order to secure the mounting bracket at a desired position and use the pulley assembly;
c) a rope cooperating with the pulley assembly in order to lift a device; and
d) a fastening means for releasably securing the device to the rope.

12. The pulley assembly of claim 111 further comprising:
a) the mounting bracket having at least one bracket aperture;
b) the at least one bracket aperture receiving the flexible strap in order to hold the mounting bracket at the desired position when the flexible strap is joined;
c) the mounting bracket having a mounting stub attached thereto; and
d) the mounting stub cooperating with a mounting rod.

13. The pulley assembly of claim 12 further comprising:
a) the mounting stub including a mounting stub aperture;
b) the mounting rod including a first mounting rod aperture;
c) a bolt fitting through the mounting stub aperture and the first mounting rod aperture;
d) the mounting rod including a second mounting rod aperture;
e) an eye bolt being mounted in the second mounting rod aperture; and
f) a pulley being mounted on the eye bolt.

14. The pulley assembly of claim 13 further comprising:
a) the rope feeding through the pulley system;
b) the rope having a device attachment in order to secure a device for lifting the device into the tree; and
c) the mounting bracket cooperating with the rope.

15. A method of mounting a hunting stand in a tree comprising:
a) providing a pulley system having a mounting bracket, a securing means, and the pulley assembly;
b) having the mounting bracket, the securing means, and the pulley assembly cooperating to permit the pulley system to work on a tree stand;
c) releasably securing the mounting bracket at a desired position on the tree with the securing means;
d) providing the pulley assembly with a rope;
e) securing one end of the rope to the hunting stand;
f) lifting the hunting stand with the rope; and
g) securing the hunting stand in a desired position.

16. The method of claim 15 further comprising:
a) the securing means being a flexible strap;
b) the flexible strap being fastenable in order to secure the mounting bracket at a desired position and use the pulley assembly;
c) a rope cooperating with the pulley assembly in order to lift a device; and
d) a fastening means for releasably securing the device to the rope.

17. The method of claim 16 further comprising:
a) the mounting bracket having at least one bracket aperture;
b) the at least one bracket aperture receiving the flexible strap in order to hold the mounting bracket at the desired position when the flexible strap is joined;
c) the mounting bracket having a mounting stub attached thereto; and
d) the mounting stub cooperating with a mounting rod.

18. The method of claim 1 7 further comprising:
a) the mounting stub including a mounting stub aperture;
b) the mounting rod including a first mounting rod aperture;
c) a bolt fitting through the mounting stub aperture and the first mounting rod aperture;
d) the mounting rod including a second mounting rod aperture;
e) an eye bolt being mounted in the second mounting rod aperture; and
f) a pulley being mounted on the eye bolt.

19. The method of claim 18 further comprising:
a) the securing means being a mounting screw;
b) the mounting screw being secured to a back of the mounting bracket; and
c) the mounting screw being securable to a tree on order to securely attach the pulley system in a desired position.

20. The pulley assembly of claim 1 9 further comprising:
a) the mounting bracket having a mounting stub attached thereto;
b) the mounting stub cooperating with a mounting rod
c) a rope cooperating with the pulley assembly in order to lift a device;
d) a fastening means for releasably securing the device to the rope;
e) the mounting stub including a mounting stub aperture;
f) the mounting rod including a first mounting rod aperture;
g) a bolt fitting through the mounting stub aperture and the first mounting rod aperture;
h) the mounting rod including a second mounting rod aperture;
i) an eye bolt being mounted in the second mounting rod aperture;
j) a pulley being mounted on the eye bolt;
k) the rope feeding through the pulley system;
l) the rope having a device attachment in order to secure a device for lifting the device into the tree; and
m) the mounting bracket cooperating with the rope.
